(19) United States
(12) Patent Application Publication
(10) Pub. No.: US 2026/0162643 A1
(43) Pub. Date: Jun. 11, 2026

(54) MULTIBEAM MICROPHONE ARRAY AND METHOD

(71) Applicant: Valeo Telematik und Akustik GmbH, Friedrichsdorf (DE)

(72) Inventor: Brandon Hook, Troy, MI (US)

(73) Assignee: Valeo Telematik und Akustik GmbH, Friedrichsdorf (DE)

(21) Appl. No.: 18/972,208

(22) Filed: Dec. 6, 2024

(51) Int. Cl. G10K 11/178

(52) U.S. Cl. CPC G10K 11/17835; G10K 11/17819; G10K 11/17881; G10K 2210/3051

(57) ABSTRACT

A method includes detecting acoustic waves with microphone capsules. The method also includes converting the detected acoustic waves into acoustic signals. The acoustic signals are transmitted from the microphone capsules to a processor with a data connection. Beams are generated from the acoustic signals with the processor using beamformers, and each beam has an ideal on-axis response and a unique off-axis null angle. The beams are processed to generate first audio samples, where each first audio sample includes a portion of a beam occupying one first sampling period, and each first audio sample is associated with a corresponding energy level. The method further includes outputting an audio signal that crossfades, using a first crossfading function, between the beams by selecting, for each first sampling period, the beam corresponding to a first audio sample having a lowest energy level.

### BACKGROUND

Processes for reducing noise in a received audio signal are complex in nature due to the number of sources from which noise may originate. As a result of the numerous noise sources that may arise, it can prove challenging to reduce noise captured by an array of microphone capsules. Additional challenges arise as a result of the term “noise” being subjective to the environment and purpose of the microphone array. For example, audio signals produced by a microphone array in the interior of a vehicle may include noise produced in the cabin of the vehicle by an entertainment system such as a stereo. On the other hand, sound waves captured by a microphone array positioned on the exterior of a vehicle may include noise associated with wind. As a result of the differing sound sources and applications for a microphone array, it is desirable to configure a microphone array for the particular environment thereof. It is further desirable to process audio signals produced by the microphone capsules of the array in such a manner so as to maximize the Signal to Noise Ratio (SNR) value of the signal(s) output by the microphone array.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method includes detecting acoustic waves with microphone capsules. The method also includes converting the detected acoustic waves into acoustic signals. The acoustic signals are transmitted from the microphone capsules to a processor with a data connection. Beams are generated from the acoustic signals with the processor using beamformers, and each beam has an ideal on-axis response and a unique off-axis null angle. The beams are processed to generate first audio samples, where each first audio sample includes a portion of a beam occupying one first sampling period, and each first audio sample is associated with a corresponding energy level. The method further includes outputting an audio signal that crossfades, using a first crossfading function, between the beams by selecting, for each first sampling period, the beam corresponding to a first audio sample having a lowest energy level.

A system includes microphone capsules, a signal processor, and a data connection. The microphone capsules detect acoustic waves and convert the detected acoustic waves into acoustic signals. The signal processor executes computer readable code. The computer readable code causes the signal processor to generate beams from the acoustic signals with the signal processor using beamformers, and each beam has an ideal on-axis response and a unique off-axis null angle. The processor processes the beams to generate first audio samples, where each first audio sample includes a portion of a beam occupying a first sampling period and is associated with a corresponding energy level. Subsequently, the processor outputs an audio signal that crossfades, using a first crossfading function, between the first audio samples by selecting, for each first sampling period, a first audio sample having a lowest energy level. The data connection transmits the acoustic signals from the microphone capsules to the signal processor.

A non-transitory Computer Readable Medium (CRM) stores instructions for performing operations. The operations include detecting acoustic waves with microphone capsules. The operations also include converting the detected acoustic waves into acoustic signals. The acoustic signals are transmitted from the microphone capsules to a processor with a data connection. Beams are generated from the acoustic signals with the processor using beamformers, and each beam has an ideal on-axis response and a unique off-axis null angle. The beams are processed to generate first audio samples, where each first audio sample includes a portion of a beam occupying one first sampling period, and each first audio sample is associated with a corresponding energy level. The operations further include outputting an audio signal that crossfades, using a first crossfading function, between the beams by selecting, for each first sampling period, the beam corresponding to a first audio sample having a lowest energy level.

Any combinations of the various embodiments and implementations disclosed herein can be used in a further embodiment, consistent with the disclosure. Other aspects and advantages of the claimed subject matter will be apparent from the following description and the claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a system in accordance with one or more embodiments disclosed herein.

FIG. 2 depicts a block diagram of a signal processing algorithm in accordance with one or more embodiments disclosed herein.

FIG. 3 depicts a block diagram of a portion of a signal processing algorithm in accordance with one or more embodiments disclosed herein.

FIG. 4 depicts a block diagram of a signal processing algorithm in accordance with one or more embodiments disclosed herein.

FIG. 5 depicts a block diagram of a portion of a signal processing algorithm in accordance with one or more embodiments disclosed herein.

FIG. 6 depicts beamforming plots in accordance with one or more embodiments disclosed herein.

FIG. 7 depicts a block diagram of a signal processing algorithm in accordance with one or more embodiments disclosed herein.

FIG. 8 depicts beamforming plots in accordance with one or more embodiments disclosed herein.

FIG. 9 depicts a block diagram of a signal processing algorithm in accordance with one or more embodiments disclosed herein.

FIG. 10 depicts a block diagram of a signal processing algorithm in accordance with one or more embodiments disclosed herein.

FIG. 11 depicts a block diagram of a portion of a signal processing algorithm in accordance with one or more embodiments disclosed herein.

FIG. 12 depicts a block diagram of a method in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, one or more embodiments of the invention as described herein are directed towards a microphone array and a signal processing algorithm that outputs a signal that crossfades between low energy beams. Embodiments of the invention as described herein further relate to a method for generating and outputting a signal that crossfades between low energy beams. The beams are generated by multiple fixed high directivity frequency invariant beamformers, each with a unique null angle, evenly distributed between 90° and 180°, and a 0 decibel (dB) gain (unity gain) along the 0° look axis. In addition, Delay-and-Sum (DAS) beamformers are utilized for beamforming in low background noise scenarios. Each beamformer's output signal is measured sample by sample to identify which has the lowest energy. Subsequently, a crossfade block is implemented to crossfade between the various beams and output a minimum energy beam. This process is continuously repeated so that the lowest energy beam is continuously output by the signal processing algorithm. Since each beamformer is designed with an identical 0° look axis, determining the minimum energy beam naturally encompasses determining the highest overall signal-to-noise ratio (SNR) for a given sample, accounting for all noise factors in the beamforming procedure, including self-noise amplification and the unique traits of each individual capsule's noise contribution.

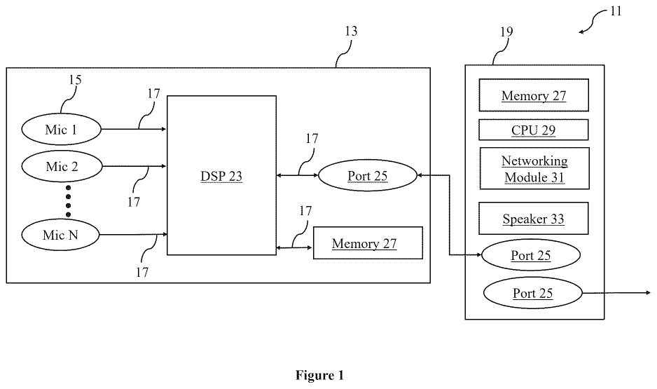

Turning to FIG. 1, FIG. 1 presents a hardware overview of an audio processing system 11 according to one or more embodiments of the invention disclosed herein. The audio processing system 11 includes a microphone array 13 that includes a plurality of microphone capsules 15. The microphone capsules 15 are embodied as Micro-Electro-Mechanical System (MEMS) microphone capsules. As is commonly known in the art, a MEMS microphone capsule includes an acoustic transducer formed as a silicone membrane (not shown) that actuates responsive to detected acoustic waves. The change in the distance between the membrane and a backplate (not shown) causes fluctuations in a change in a capacitance value output by the membrane and backplate, and the capacitance value is subsequently converted to an acoustic signal corresponding to the detected acoustic waves. Each microphone capsule 15 is also embodied as an omnidirectional capsule, such that the microphone capsule 15 is sensitive to sound in all directions as opposed to being a unidirectional microphone capsule that is most sensitive in a single direction (i.e., a cardioid microphone).

The microphone capsules 15 are denoted with ordinal numbers (i.e., “Mic 1,” “Mic 2,” . . . “Mic N,”) to represent separate physical instances of a microphone capsule 15. Such is not considered to be limiting with respect to the number of microphone capsules 15 included in a particular audio processing system 11. In this regard, and as will be explained further below, the minimum number of microphone capsules 15 in an audio processing system 11 is two microphone capsules, but the audio processing system 11 may be expanded to include any number of microphone capsules 15. In addition, the microphone capsules 15 are physically spaced apart by a distance known to the manufacturer thereof. Such a separation distance is typically measured on the order of millimeters or centimeters, but may be applicable to larger distances if designed to accommodate for the natural design differences therebetween.

Each microphone capsule 15 is connected to a Digital Signal Processor (DSP) 23 by way of a corresponding data connection 17. The data connections 17 form electrically connective pathways between the microphone capsules 15 and the DSP 23. In embodiments where the microphone capsules 15 are separated by short distances (i.e., on the order of millimeters or centimeters), the data connections 17 are embodied as an electrically conductive layer of a printed circuit board (not shown). In embodiments of the audio processing system 11 where the microphone capsules 15 are separated by large distances (i.e., on the order of meters), the data connections 17 may be embodied as wiring harnesses (not shown). Regardless of the particular embodiments, the data connections 17 serve to form electrical pathways for transmitting audio signals captured by the microphone capsules 15 to the DSP 23, and from the DSP 23 to the computing device 19. Furthermore, an audio processing system 11 may include both printed circuit boards and wiring harnesses without deviating from the nature of this disclosure.

The microphone capsules 15 are configured to detect acoustic waves and convert the detected acoustic waves into corresponding acoustic signals. Acoustic waves may be generated by one or more sources. By way of nonlimiting examples, acoustic waves in automotive applications may be generated by sources such as vibrating mechanical components of the vehicle, occupants or operators of the vehicle, and/or the surrounding environment. In the context of this application, the phrase “acoustic” refers to a sound wave which produces correlated signals on closely spaced microphone capsules, when the wavelength is greater than the distance between two or more microphone capsules.

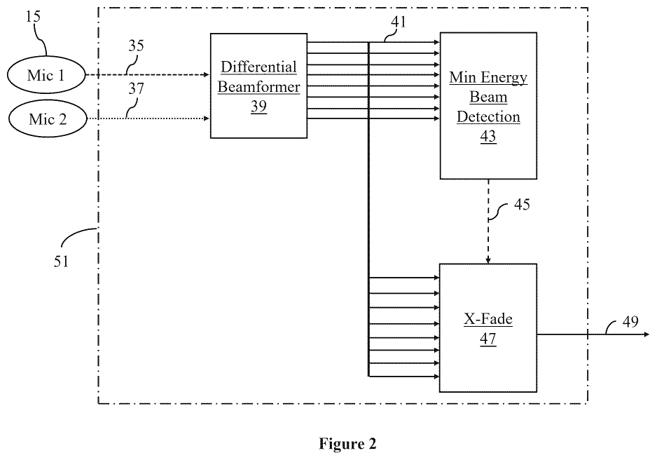

The acoustic signals generated by the microphone capsules 15 are transferred to a Digital Signal Processor (DSP) 23 by way of data connections 17. The DSP 23 is formed by one or more processors, integrated circuits, microprocessors, or equivalent computing structures that serve to execute computer readable instructions stored on the memory 27. The DSP 23 processes the acoustic signals using operations described further in relation to FIGS. 2-11. In general terms and although not depicted in FIG. 1, the DSP 23 functions to generate a plurality of beams from the acoustic signals using a plurality of beamformers, where each beam of the plurality of beams comprises an ideal on-axis response and a unique off-axis null angle. The DSP 23 processes the plurality of beams to generate a plurality of first audio samples, where each first audio sample of the plurality of first audio samples is a short time segment of a beam (i.e., a time slice or a part of the beam occupying a specific duration in the time domain) of the plurality of beams occupying one first sampling period of a plurality of first sampling periods. Thus, each first audio sample is naturally associated with a corresponding energy level, and the DSP 23 functions to determine the audio sample and corresponding beamformer having a lowest energy level among a plurality of audio samples for a given time period. The DSP 23 proceeds to output an audio signal that crossfades, using a first crossfading function, between the plurality of beams by selecting, for each first sampling period, the beam corresponding to a first audio sample having a lowest energy level. Instructions for performing these functions may be stored on program memory (not shown) of the DSP 23 and executed by a computing engine (not shown) of the DSP 23 as is commonly known in the art.

The audio signal output by the DSP 23, which may be referred to as a “crossfaded output audio signal” or an “output signal” herein, is transmitted to a computing device 19 by way of a data port 25. The data port 25, similar to the data connections 17, may be embodied in many forms according to the contemplated use case of the audio processing system 11. For example, in embodiments where the microphone array 13 is formed as an Automotive Audio Bus (A²B) device including MEMS microphone capsules 15 as depicted in FIG. 1, the data port 25 may be omitted entirely, and the data connection 17 is formed as a DSP 23 output line connected to the computing device 19, where the computing device 19 includes a head unit (not shown) of a vehicle (not shown). In alternative embodiments, the microphone array 13 may encompass stand-alone microphone devices such as an array of stand-alone microphones connected to a central computer. The data port 25 is then embodied as one or more Universal Serial Bus (USB) ports or a wireless transceiver (e.g., a wireless networking card such as a Bluetooth card or a Wi-Fi card) that receives the crossfaded output audio signal and transmits the crossfaded output audio signal to the computing device 19. In yet another embodiment where the microphone array 13 is formed as a sound card encompassing functions of the DSP 23, the data port 25 may take the form of a Peripheral Component Interconnect express (PCIe) connection. Thus, it will be appreciated to a person having ordinary skill in the art that the particular structure of the microphone array 13 is not limited to the above description or the depiction in FIG. 1, and many modifications are possible without departing from the nature of this disclosure. That is, FIG. 1 presents one possible physical embodiment of a system capable of detecting, converting, and processing acoustic waves, and any number of alternative configurations that perform similar audio processing functions may be substituted for the configuration of FIG. 1 without departing from the core concepts of the invention.

Similar to the DSP 23, the computing device 19 has a form and components corresponding to the contemplated use case. In the context of FIG. 1, the computing device 19 is depicted as including data ports 25, a memory 27, a networking module 31, a Central Processing Unit (CPU) 29, and a speaker 33. The computing device 19 itself may take the form of a smart phone, a tablet, a desktop computer, a laptop, a head unit (not shown) of a vehicle (not shown), or equivalent devices as will be appreciated by a person having ordinary skill in the art.

The memory 27 stores computer readable code forming operating instructions for the microphone array 13 and the computing device 19, and is embodied as a Computer Readable Medium (CRM) comprising a non-transitory storage medium such as a Solid State Drive (SSD), a Hard Disk Drive (HDD), or Electrically Erasable Programmable Read-Only Memory (EEPROM), or a transitory storage medium such as flash memory, for example. More specifically, the memory 27 stores code forming operating instructions for facilitating and enabling processes further discussed below in relation to FIGS. 2-11, and further stores drivers for connected components such as the microphone array 13. In embodiments where the microphone array 13 is a standalone device separate from the computing device 19, the computer code may be copied to the DSP 23 from the memory 27 of the computing device 19 during a process of manufacturing the microphone array 13. In embodiments when the microphone array 13 and the computing device 19 are formed as a single device, the memory 27 may store the instructions and the DSP 23 executes instructions received directly from the memory 27. Such is illustrated by the memory 27 connected directly to the DSP 23 in FIG. 1, but it will be appreciated that the particular type and function of the memory 27 may vary according to the contemplated use case of the microphone array 13. The memory 27 may further store one or more signals generated by the DSP 23, including, but not limited to, the crossfaded output audio signal or a time domain portion thereof, and the generated audio samples.

The CPU 29 functions to execute instructions stored on the memory 27. The CPU 29 may include one or more processors, integrated circuits, microprocessors, or equivalent computing structures that serve to execute computer readable instructions stored on the memory 21. While the computer code executed by the DSP 23 is narrowly tailored for performing audio signal processing as discussed in relation to FIGS. 2-11, the CPU 29 executes computer code for performing general computer functions in addition to the audio signal processing functions. For example, the CPU 29 may store additional computer code that allows the computing device 19 to interface with other devices, such as drivers for peripheral devices (i.e., a monitor, a keyboard, a computer mouse). The CPU 29 may further execute computer code forming Graphical User Interfaces (GUIs) for audio signal visualizations such as beamforming plots as discussed further below. In addition, the CPU 29 may store computer code that, when executed, allows an operator or system engineer to adjust audio signal processing parameters as discussed below. As noted above, computer code executed by the CPU 29 is stored on the memory 27.

The networking module 31 serves to transmit the crossfaded output audio signal to other devices. The form of the networking module 31 corresponds to the contemplated use case thereof. For example, in cases where the computing device 19 transmits an output audio signal to Bluetooth headphones, the networking module 31 may include a Bluetooth chip as discussed above. Alternatively, in internet based applications where the audio processing system 11 transmits a digital audio signal to a server, the networking module 31 may include a Wi-Fi transceiver. Furthermore, the networking module 31 may be embodied as one or more wired networking connections such as a Local Area Network (LAN) port or an Ethernet port.

The speaker 33 of FIG. 1 comprises similar components to the microphone capsules 15, and operate by inducing a magnetic field that causes a coil (not shown) fixed to a diaphragm (not shown) to vibrate and produce sound waves that correspond to a received signal. In the case of an “In-Car-Communication” system (ICC), the signal received by the speaker 33 and converted into sound waves is the crossfaded output audio signal generated by the microphone array 13. Although a single speaker 33 is depicted in FIG. 1, an audio processing system 11 may include any number of speakers 33. For example, a vehicle (not shown) comprising a computing device 19 formed as an ECU may be configured with a plurality of speakers 33, and each speaker 33 outputs soundwaves corresponding to the crossfaded output audio signal. When the computing device 19 includes multiple speakers 33, the amplitude of sound waves produced by one speaker 33 may vary or be the same as the amplitude of sound waves produced by another speaker 33.

The computing device 19 further includes data ports 25. A first data port 25 of the computing device 19 functions to receive the crossfaded output audio signal from a corresponding data port 25 via the data connection 17. The first data port 25 of the computing device 19 has a structure corresponding to the data port 25 of the microphone array 13. The second data port 25 functions to transmit the crossfaded output audio signal from the computing device 19, and may be embodied as a USB port or similar ports as discussed above. As discussed above, the data ports 25 may be embodied as a USB port, in which case the data connection 17 is formed as a USB cable. In one or more alternative embodiments, the data connections 17 and the data port 25 may be combined and embodied as electrically connective pathways of a printed circuit board. In yet another embodiment, the data port 25 may include a wireless networking card and the data connection 17 between the microphone array 13 and the computing device 19 is a corresponding wireless data signal.

Thus, overall, FIG. 1 depicts an audio processing system 11 that is capable of generating an audio signal from sound waves, processing said audio signal to generate a crossfaded output signal, and generating sound corresponding to the output signal as discussed further below. It will be appreciated to a person having ordinary skill in the art that the particular structure of the microphone array 13 and the computing device 19 will vary according to the contemplated use case of the invention. The microphone array 13 and the computing device 19 are not limited to a single embodiment, and it will also be appreciated that any embodiment presented in this disclosure may be adapted according to the desired functions and constraints of the audio processing system 11. For example, the use of a microphone array 13 on the exterior of a vehicle (not shown) to reduce noise associated with wind will have different packaging requirements from a microphone array 13 packaged for use on the vehicle interior for voice pickup, or packaged in a smartphone and configured to reduce background call noise. In such a case, the microphone array 13 positioned on the exterior of the vehicle may be afforded a larger packaging space than a microphone array 13 of a smartphone, but the microphone array 13 of the vehicle will require a robust packaging (not shown) to survive weather conditions experienced by the vehicle.

Turning to FIG. 2, FIG. 2 depicts a block diagram overview of a signal processing algorithm 51 that functions to generate a crossfaded output audio signal out_{x_fade}(t) 49 from acoustic audio signals output by the microphone capsules 15. The blocks of FIG. 2 visually depict sections of computer code or instructions executed by the DSP 23 or computing device 29. In FIG. 2, a first microphone capsule 15 outputs a first audio signal mic1(t) 35, and a second microphone capsule 15 outputs a second audio signal mic2(t) 37. The values mic1(t) and mic2(t) respectively correspond to values of the audio signal at a specific time slice “t”. Each of the mic1(t) 35 and the mic2(t) 37 correspond, in phase and amplitude, to acoustic waves produced by one or more acoustic sources. The acoustic sources include noise such as, for example, background traffic sounds, mechanical noise, and/or sounds emanating from a person who is not a source of interest. The sound sources also include sounds of interest, such as speech detected from an operator of a vehicle (not shown) or an operator of a smartphone (not shown). The audio signals 35 and 37 also correspond, in phase and amplitude, to non-acoustic stimuli, such as wind currents perturbing the capsule (sometimes referred to as wind buffeting), and electrical noise in the physics and electronics of microphones 15. In this way, the source of interest and noise sources are related to the particular environment of the microphone array 13 as a whole, and are further associated with the specific configuration and embodiment of the microphone array 13.

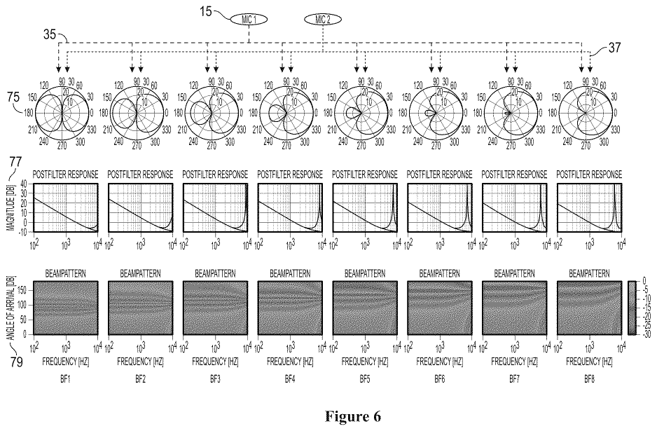

The first audio signal mic1(t) 35 and the second audio signal mic2(t) 37 are transmitted from the microphone capsules 15 to a differential beamformer block 39. A detailed example of the differential beamformer block 39 is presented in FIG. 2, and is further discussed below. The output of the differential beamformer block 39 is a plurality of differential beams (n,t) 41, where “n” denotes the index of the associated differential beamformer and “t” denotes the associated time slice. Each differential beam (n,t) 41 corresponds to a separate signal produced by the differential beamformer block 39 by applying a unique delay (d_diff) to second audio signal mic2(t) 37 to form a delayed audio signal mic2_{d_diff} (t) 37, subtracting the delayed second audio signal mic2_{d_diff} (t) 37 from the first audio signal mic1(t) 35, and applying a postfilter to the resulting differential signal. The differential beams (n,t) 41 are time and phase aligned relative to a main design axis, where the main design axis is assigned a zero degree look angle by convention. Thus, all of the differential beams (n,t) 41 will respond identically to a sound source of interest located at the look angle (i.e., at zero degrees, or in the direction the microphone array 13 is physically facing). On the other hand, each differential beam (n,t) 41 will have a unique polar pattern (e.g., FIG. 6) and differing noise levels associated therewith. Once the differential beams (n,t) 41 are formed by the differential beamformer block 39, the differential beams (n,t) 41 are transmitted to a minimum energy detection block 43.

The minimum energy detection block 43 is configured to determine which differential beam (n,t) 41 output by the differential beamformer block 39 has the lowest energy, or lowest absolute magnitude over a given duration. The given duration is selected by a manufacturer of the system, and relates to a processing rate of a processor. In the context of this disclosure, the DSP 23 operates at a processing rate of at least 48 Kilohertz (kHz) to provide sufficient sampling granularity. The processing rate may vary, as a high processing rate increases system overhead and a low processing rate decreases system responsivity, and may not be sufficient to capture the bandwidth of the signals of interest. Thus, the processing capabilities of the DSP 23 are selected depending on logistical considerations such as processing power and system capability, and the DSP 23 is not limited to a particular processing rate.

The minimum energy detection block 43 further includes an absolute value function and a minimum (min) function, mathematically expressed as min (absval (beams (n,t))). The absolute value function determines the absolute value of the magnitudes of the differential beams (n,t) 41. The min function indexes the beams according to their magnitude and outputs, to the crossfade block 47, a beam index (n) corresponding to the instantaneous min energy for the current sample period. The index (n) of the differential beam (n,t) 41 having the lowest absolute magnitude is output as a selected beam index (n) 45 to a cross fade block 47. As noted above, each differential beam (n,t) 41 corresponds to a polar pattern (e.g., FIG. 6) with an identical 0° look axis. Given the identical look angle, identifying the minimum energy beam through the minimum energy detection block 43 inherently determines the beam with the highest overall Signal to Noise Ratio (SNR), assuming the signal of interest aligns with the main look direction. That is, the selected beam index (n) 45 conveyed by the minimum energy detection block 43 is the index (n) of the differential beam (n,t) 41 having the highest SNR value among the plurality of differential beams (n,t) 41. The selected beam index (n) 45 is transferred from the minimum energy detection block 43 to a crossfade block 47.

The crossfade block 47 generates a crossfaded output audio signal out_{x_fade} (t) 49 based upon the differential beams (n,t) 41 and the selected beam index (n) 45. Specifically, the crossfade block 47 is configured to fade out a previously selected beam corresponding to a previously selected beamformer with index “m” (i.e., a first beam (m, t−1)) and fade in the beam corresponding to the selected beam index (n) 45 (i.e., a second beam (n, t)) determined by the minimum energy detection block 43. In this regard, the phrase “previously selected beam” refers to a beam that was determined by the minimum energy detection block 43 to have the lowest absolute magnitude, or lowest energy, during the previous sampling period (t−1) prior to the sampling period (t) where the minimum energy detection block 43 outputs the selected beam index (n) 45. The phrase “crossfade” refers to a combined output signal that includes two or more output audio signals multiplexed in the time domain. Thus, the crossfaded output audio signal out_{x_fade}(t) 49 includes the previously selected beam (m, t−1) and the currently selected beam (n, t), where the current beam (n,t) is selected in an open loop fashion and does not depend on the previously selected beam (m, t−1). In one or more alternative embodiments, the output audio signal out_{x_fade}(t) 49 may include fade values (or attenuation values) and gain values applied to the previously selected beam (m, t−1) and the currently selected beam (n, t). In further embodiments, the previously selected beam (m, t−1) may be faded out while the currently selected beam (n, t) is faded in.

As is depicted in FIG. 2, the crossfade block 47 receives the plurality of differential beams (n,t) 41 from the differential beamformer block 39, and also receives the selected beam index (n) 45 from the minimum energy detection block 43. As noted above, the differential beams (n,t) 41, as derived from the microphones 15, are sampled incrementally, capturing discrete values at each sampling interval. These sequentially acquired values, referred to as ‘first audio samples,’ represent the audio signal in a form that allows for detailed sample-by-sample processing. Similarly, in the context of this disclosure, the plurality of sampling periods analyzed by the crossfade block 47 are denoted as “first sampling period (t)” for simplicity. Thus, the crossfade block 47 analyzes a plurality of first audio samples generated from the differential beams (n,t) 41, where each first audio sample of the plurality of first audio samples comprises a portion of a beam of the plurality of differential beams (n,t) 41 occupying one first sampling period (t) of a plurality of first sampling periods (t). The crossfade block 47 proceeds to output a crossfaded output audio signal out_{x_fade}(t) 49 that crossfades, using a crossfading function, between the plurality of differential beams (n,t) 41 by selecting, for each first sampling period (t), the differential beam (n,t) 41 corresponding to a first audio sample having a lowest energy level. As a result, the crossfaded output audio signal out_{x_fade}(t) 49 is formed of audio samples taken from the differential beams (n,t) 41, where the crossfade block 47 smoothly blends the samples to ensure that the crossfaded output audio signal out_{x_fade}(t) 49 appears to be naturally generated by one or more sound source(s) of interest. The procedure of FIG. 2 also beneficially mitigates self-noise amplification effects from the differential beamforming process by virtue of adapting the crossfaded output audio signal out_{x_fade}(t) 49 to reflect the differential beam (n,t) 41 having the lowest energy.

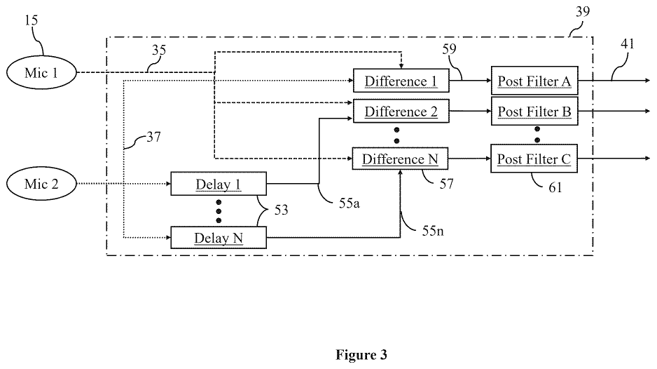

Turning to FIG. 3, FIG. 3 depicts a detailed block diagram overview of the differential beamformer block 39 depicted in FIG. 2. The differential beamformer block 39 depicted in FIG. 3 forms one representative example of a differential beamforming process, and additional or alternative processing steps may be utilized without departing from the nature of this disclosure. As shown in FIG. 3, the differential beamformer block 39 receives a first audio signal mic1(t) 35 from the first microphone capsule 15 and receives a second audio signal mic2(t) 37 from the second microphone capsule 15. The differential beamformer block 39 serves to form a plurality of differential beams (n,t) 41 using a plurality of differential beamformers. Each differential beamformer is formed including a delay function, a difference function, and a filter function. The delay function is depicted as delay blocks 53, the difference function is depicted as difference blocks 57, and the filter function is depicted as differential postfilter blocks 61.

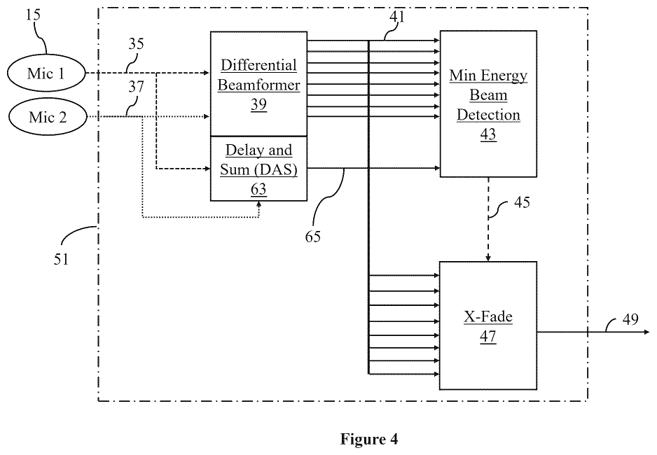

Initially, the second audio signal mic2(t) 37 is transmitted to a plurality of delay blocks 53. Each delay block 53 applies a unique delay (d_diff), or time domain shift, to its corresponding second audio signal mic2(t) 37. For example, a first delay (d1_diff) is applied to one second audio signal mic2_{d1_diff} (t) 37 with a first delay block 53, and a second delay (d2_diff), different from the first delay (d1_diff), is applied to another second audio signal mic2_{d2_diff} (t) 37 via a second delay block 53. The applied delay (d_diff) is on the order of microseconds (μs), and the delay (d_diff) is applied in real time to the second audio signal mic2(t) such that the differential beams (n,t) are formed in real time. In addition, the delay blocks 53 each add an additional compensatory delay (d_c) to all inputs to the differential beamformer block 39 as discussed further below in relation to FIG. 4.

The minimum delay (d_diff) depends upon the spacing between microphone capsules 15, but generally relates to the amount of time necessary for sound to travel the distance between microphone capsules 15. Assuming the speed of sound to be approximately 343 meters (m) per second(s) and a 7 millimeter (mm) microphone capsule 15 spacing, the DSP 23 applies a maximum delay of 21 μs to ensure that a sound wave has enough time to cross the distance between two capsules. As a second example, if the microphone capsules 15 are spaced 28 mm apart, the DSP 23 applies a maximum delay of 84 μs. These maximums ensure that the null angle is never exceeding 180 deg, which is the maximum null angle achievable in a first order differential design. Each delay block 53 outputs a separate delayed second audio signal mic2_{dN}(t) 55 to a corresponding difference block 57, which represents the difference functions of the differential beamformers. For example, a first delay block 53 (denoted as Delay 1 in FIG. 3) outputs a delayed second audio signal mic2_{d1_diff} (t) 55a, whereas an N^{th} delay block 53 outputs a delayed second audio signal mic2_{dN_diff} (t) 55n.

The difference blocks 57 serve to form a plurality of unfiltered differential beams (n,t) 59. Each unfiltered differential beam (n,t) 59 is a signal formed by subtracting a delayed second audio signal mic2_{d_diff} (t) 55 from a first audio signal mic1(t) 35. In this process, the first audio signal mic1(t) 35 is transmitted to each of the difference blocks 57. Each difference block 57 further receives a corresponding separate delayed second audio signal mic2_{d_diff} (t) 55 from an associated delay block 53. The difference block 57 computes the difference, in amplitude, between the two signals by subtracting the delayed second audio signal mic2_{dN} (t) 55 from the first audio signal mic1(t) 35 in a sample-by-sample fashion. Each difference block 57 produces a unique unfiltered differential beam (n,t) 59 that is transmitted to an associated differential postfilter block 61.

The differential postfilter blocks 61 represent a plurality of first order filters with a “1/f” shape, where “f” denotes frequency. The differential postfilter blocks 61 compensate for the progressive insensitivity of the input signal arrays (i.e., the plurality of unfiltered differential beams (n,t) 59) at lower frequencies. That is, the overarching goal of the differential postfilter blocks 61 is to flatten the response of the beamformer (formed by a delay block 53 and a difference block 57 pair) to be equally sensitive in the main axis (0 deg) for all frequencies up to a spatial aliasing frequency limit. In the context of this disclosure, the term “spatial aliasing frequency limit” is mathematically defined to be:

fₗᵢₘᵢₜ=c/2d (1)

Where “fₗᵢₘᵢₜ” denotes the spatial aliasing frequency limit, “c” denotes the speed of sound in air, and “d” denotes a distance between the microphone capsules 15. Visual examples of postfilters formed by the differential postfilter blocks 61 are depicted in FIG. 6 and are discussed further in relation thereto. This “flimit” represents the maximum frequency before spatial aliasing occurs, for a dipole design, where the delay (d_diff) utilized by the delay block 53 is equal to zero, producing a null at 90 degrees relative to the main axis. The “flimit” decreases by up to a factor of 2, as the delay 53 approaches the maximum delay for the given spacing, producing a null at 180 degrees.

The output of the differential postfilter blocks 61, and the output of the differential beamformer block 39 as a whole, is a plurality of differential beams (n,t) 41. The differential beams (n,t) 41 are transmitted to a minimum energy detection block 43 as discussed in relation to FIG. 2, and a crossfaded output audio signal out_{x_fade}(t) 49 is ultimately formed of samples taken from the differential beams (n,t) 41. Thus, passing the plurality of unfiltered differential beams (n,t) 59 through unique differential postfilter blocks 61 advantageously allows the resulting crossfaded output audio signal out_{x_fade}(t) 49 to be formed of samples taken by beamformers having equivalent sensitivity to all frequencies less than the spatial aliasing frequency limit.

Turning to FIG. 4, FIG. 4 depicts a second signal processing algorithm 51 consistent with one or more embodiments of the invention described herein. In juxtaposition to FIG. 2, the signal processing algorithm 51 of FIG. 4 includes both a differential beamformer block 39 and a Delay and Sum (DAS) beamformer block 63. The differential beamformer block 39 of FIG. 4 functions similar to the differential beamformer block 39 of FIG. 2.

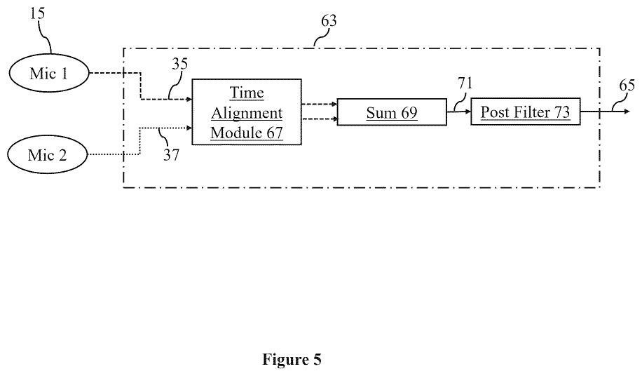

The DAS beamformer block 63 functions to create a DAS beam (n,t) 65 formed by time-aligning and summing the first audio signal mic1(t) 35 and the second audio signal mic2(t) 37. The formation of the DAS beam (n,t) 65 is further discussed in relation to FIG. 5, and involves performing time-alignment functions, summation functions, and postfiltering functions. The DAS beam (n,t) 65 is subsequently transmitted to the minimum energy detection block 43, and the minimum energy detection block 43 considers the DAS beam (n,t) 65 while determining the beamformer that produces the lowest energy beam for the current sampling period. Overall, the expanded signal processing algorithm 51 depicted in FIG. 4 allows for a signal with a lower electrical noise as an input to the minimum energy detection block 43.

Specifically, in low acoustic noise conditions, the DAS beam (n,t) 65 will be favored over the differential beams (n,t) 41 since it has lower electrical noise in its output signal. As a result of the DAS beamforming process, any uncorrelated noise present on the microphone capsules 15 will be mapped into the DAS beam (n,t) 65 with a 10*log (n) dB reduction in noise, while keeping the signal of interest equal to that of a single microphone capsule 15. In contrast, the differential beamformer block 39 employs difference blocks 57 with a progressive bass-boost as a consequence of the 1/f filter shape. Thus, the differential beams (n,t) 41 exhibit lower electrical SNR since the differential postfilter blocks 61 progressively boost the electrical noise floor thereof. In summary, the use of both differential type beamformers (i.e., the differential beamformer block 39) and one or more DAS type beamformers (i.e., the DAS beamformer block 63) allows the signal processing algorithm 51 to flexibly operate in low noise and high noise conditions while still producing an crossfaded output audio signal out_{x_fade}(t) 49 with a maximized SNR.

FIG. 5 depicts a detailed block diagram overview of a DAS beamformer block 63. As depicted in FIG. 5, the DAS beamformer block 63 receives and time and phase aligns the first audio signal mic1(t) 35 and the second audio signal mic2(t) 37 with a time alignment module 67. The time alignment module 67 is implemented because DAS beamforming involves delaying a signal (i.e., mic1(t)) captured by a microphone capsules 15 closest to a sound source of interest to align with a signal captured by a microphone capsules 15 located further from the sound source of interest (i.e., mic2(t)). Such is in contrast to a differential type of beamformer embodied by the differential beamformer block 39, where a delay (d_diff) is added to the audio signal captured by a microphone capsule 15 located further from the sound source (i.e., mic2(t)). In order to ensure time alignment between the differential beams (n,t) 41, all of which are time aligned to the front-most capsule 15, with the DAS beams (n,t) 65, all of which are time aligned to the rear-most capsule, a necessary additional compensatory delay (d_c) is added to all the inputs to the differential beamformer block 39. The value of this compensatory delay (d_c) is equal to the maximum delay value (d_DAS) which is used in the DAS block 63. Building off of the example embodiment of the differential beamformer block 39 provided in FIG. 3, which includes applying a delay (d_diff) to the second audio signal mic2(t) 37 to form a delayed second audio signal mic2_{d_dif} (t) 55, a DAS beamformer block 63 as depicted in FIG. 4 would delay the first audio signal mic1(t) 35 instead of the second audio signal mic2(t) 37. The delay (d_DAS) applied by the time alignment module 67 to the first audio signal mic1(t) 35 is also applied by the differential beamformer block 39 in the delay block 53 as the additional delay (d_c), in addition to the unique delay (d_diff) applied by the delay block 53.

The sum block 69 of the DAS beamformer block 63 adds the time aligned signals output by the time alignment module 67 to form an unfiltered DAS beam (n,t) 71. Summing the time and phase aligned signals output by the time alignment module 67 involves performing moment-by-moment addition to combine the first audio signal mic1(t) 35 and the second audio signal mic2(t) 37. That is, the unfiltered DAS beam (n,t) 71 output by the sum block 69 is practically embodied by adding the aligned first audio signal mic1(t) 35 to the second audio signal mic2(t) 37. Once the unfiltered DAS beam (n,t) 71 is output by the sum block 69, the unfiltered DAS beam (n,t) 71 is filtered and weighted by the DAS postfilter block 73.

The DAS postfilter block 73 employes a 1/N weighting function, where “N” is the number of microphone capsules 15 implemented in the microphone array 13. In the DAS postfilter block 73 the signal forming the unfiltered DAS beam (n,t) 71 is divided by N, or the number of microphone capsules 15. Thus, the DAS beamformer block 63 may be practically embodied as a “delay-and-average” signal processing function by virtue of time aligning and summing signals output by the microphone capsules 15 and dividing the summation by the number of microphone capsules 15. The output of the DAS postfilter block 73 is a DAS beam (n,t) 65. As described in relation to FIG. 4, the DAS beam (n,t) 65 is transmitted from the DAS beamformer block 63 to the minimum energy detection block 43. Samples taken from the DAS beam (n,t) 65 may then be utilized in the crossfading process performed by the crossfade block 47.

Thus, in the embodiment depicted in FIGS. 4 and 5, the crossfaded output audio signal out_{x_fade}(t) 49 may take varying forms depending on the corresponding local environment of the microphone array 13. In low acoustic noise conditions, the DAS beam (n,t) 65 will be favored and the crossfaded output audio signal out_{x_fade}(t) 49 may include samples taken solely from the DAS beam (n,t) 65. On the other hand, a microphone array 13 operating in environments producing a large amount of correlated noise will favor the differential beams (n,t) 41, and the crossfaded output audio signal out_{x_fade}(t) 49 may include samples taken solely from the differential beams (n,t) 41. As a further result of the crossfade block 47 and minimum energy detection block 43, it is possible to combine the signals such that the crossfaded output audio signal out_{x_fade}(t) 49 includes samples from both beamformer types in environments with varying sound levels.

Having described the operation of the differential beamformer block 39 above, FIG. 6 provides visualizations of the differential beamforming process and results thereof. FIG. 6 is organized as a series of rows and columns. The top row of FIG. 6 depicts polar patterns 75. The middle row of FIG. 6 depicts postfilter noise penalty visualizations 77 implemented by the differential postfilter blocks 61 of the differential beamformer block 39. The bottom row of FIG. 6 depicts beampatterns 79 visualizing the differential beam (n,t) 41 created by the corresponding differential beamformer. The columns of FIG. 6 denote separate beamformers that are distinct by virtue of a unique delay (d_diff) being implemented therein. For example, the column denoted “BF1” in FIG. 6 is associated with a delay block 53 different from the column denoted “BF2” in FIG. 6. A first microphone capsule 15 and a second microphone capsule 15 are depicted in FIG. 6 to represent that each resulting differential beam (n,t) 41 is formed using the first audio signal mic1(t) 35 and the second audio signal mic2(t) 37.

In general, the curves of the polar patterns 75 represent the sound sensitivity, in Decibels (dB), of the corresponding beamformer, as a function of a sound's incident angle. For example, the polar pattern 75 associated with BF1 has full sensitivity at zero degrees (the look axis), and at 180 degrees (opposite the look axis). The polar pattern 75 associated with BF1 is insensitive to sounds orthogonal to the look axis, such as those that originate at 90 degrees and 270 degrees relative to the look axis. Such a polar pattern 75 is commonly referred to as a “bidirectional polar pattern” or a “dipole polar pattern” in the art of audio signal processing. The polar patterns associated with BF2 through BF7 form a range of polar patterns, whose null angle incrementally shifts from 90 degrees to 180 degrees. Commonly used terminology to identify the polar patterns includes names such as a cardioid polar pattern (null at 180 degrees), a supercardioid polar pattern (null angles between 150 and 120 Degrees), and a hypercardioid polar pattern (null angles between 150 and 120 Degrees). These polar patterns each have two null angles, specified by a null between 90 and 180 degrees, and its symmetric double reflected about the 0-180 axis. The beamformers are extremely insensitive to sounds arriving from the direction of the null angle. he polar pattern 75 corresponding to BF8 has a “cardioid” shape, and only has one null angle located opposite the look axis (i.e., a 180 degree null angle).

As can be seen in FIG. 6, the polar patterns 75 each have maximum sensitivity at the look axis (i.e., zero degrees). As a result, all of the beamformers are equally sensitive to sounds produced by a source of interest located on the look axis. The beamformers are each configured with different null angles, and thus capture sounds from sources not located on the look axis at different sensitivities. As a result, the beam having the lowest minimum energy corresponds to a polar pattern 75 of a beamformer that has a null angle pointing towards a noise source, such that the noise is attenuated by the beamformer.

The postfilter noise penalty visualizations 77 depict the first order nature of the differential postfilter blocks 61. As discussed above, each differential postfilter block 61 employs a first order postfilter having a unique “1/f” shape. Each differential postfilter block 61 operates with the goal of flattening the beamformer response such that the associated differential beamformer is equally sensitive to all frequencies up to the spatial aliasing frequency limit. The unique nature of each beamformer is depicted in the postfilter noise penalty visualizations 77 by virtue of each beamformer having a separate gain applied to its corresponding unfiltered differential beam (n,t) 59.

For example, the dipole polar pattern 75 associated with BF1 corresponds to a postfilter noise penalty visualization 77 that applies a gain of approximately 26 dB to frequencies of 10 Hz. At the same frequency, the cardioid polar pattern 75 associated with BF8 corresponds to a postfilter noise penalty visualization 77 where a 20 dB gain is applied. 10² Hz generally defines the feature of interest limit for a microphone array 13, such that frequencies less than 10² Hz are considered to be unwanted. It is further noted that noise captured by a microphone capsules 15 above the noise floor combines with the signal of interest captured by the microphone capsules 15 via root mean square (RMS) adding, since they are uncorrelated to each other. Thus, based on the postfilter noise penalty visualizations 77 of FIG. 6, the dipole polar pattern 75 of BF1 requires a postfilter that amplifies self-noise 6 dB more than the cardioid polar pattern 75 of BF8 in order for BF1 to have the same response on the main look axis as BF8.

The postfilter design is also influenced by the spacing of the microphone capsules 15. Thus, at smaller spacings (i.e., 7 mm capsule spacing), the postfilter design requires greater gain than that of large spacings (i.e., 28 mm spacing). For example, in a 7 mm spacing case the postfilter will amplify self-noise greater than a postfilter for a 28 mm spacing case. Continuing with this example, the postfilter design for the 7 mm spacing case will reach a gain of 0 dB at a frequency greater than that of the 28 mm case. Thus, in addition to being a function of the beamformer design (i.e., the beamforming delay (d_diff)), the postfilters applied by the differential postfilter blocks 61 are a function of capsule 15 spacing as well.

The beampatterns 79 illustrate the directivity of the differential beamformers formed by the differential beamformer block 39. Specifically, each beampattern 79 depicts its corresponding beamformer response as a function of angle-of-arrival and frequency. For example, the beampattern 79 associated with BF1 depicts null angles (i.e., >−30 dB attenuation) at 90 degrees and 270 degrees, and further depicts full sensitivity (i.e., 0 dB attenuation) at 0 and 180 degrees. On the other hand, the beampattern 79 associated with BF8 depicts a null angle at approximately 180 degrees, and has full sensitivity at 0 degrees.

The beampatterns 79 further depict spatial aliasing frequency limits of the beamformers. The curved band appearing at approximately 104 Hz for each beampattern 79 represents the effects of spatial aliasing. Spatial aliasing occurs when the spacing between microphone capsules is too large relative to the wavelength of the signal being captured. This results in the misinterpretation of the sound's directionality, causing artifacts in the beamforming process. In the context of this disclosure, spatial aliasing can degrade the accuracy of the differential beam (n,t) 41 by introducing errors in directional sensitivity at higher frequencies. However, DAS beams such as the DAS beam (n,t) 65 don't experience aliasing on the design axis, and thus a signal processing algorithm 51 may prefer the DAS beam (n,t) 65 to replace portions of the frequency spectrum that may otherwise be aliased from differential beams (n,t) 41. A “cross-over” may be implemented to roll off high (aliased) frequencies of the differential beams (n,t) 41, whereas low frequencies from the DAS beam (n,t) 65 may be rolled off. The summation of these beams results in a balanced frequency spectrum sensitivity without experiencing substantial spatial aliasing effects.

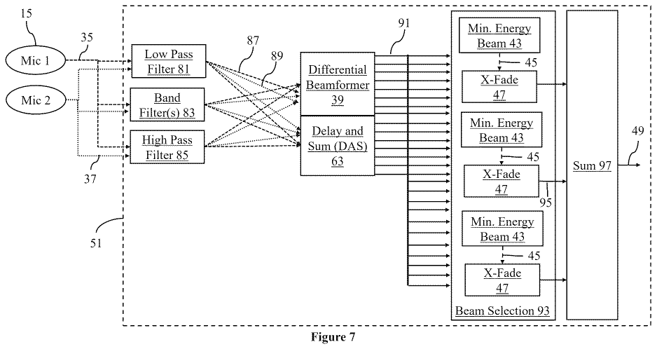

Turning to FIG. 7, FIG. 7 depicts a block diagram of a signal processing algorithm 51 consistent with one or more embodiments of this disclosure. The signal processing algorithm 51 of FIG. 7 functions similar to the signal processing algorithm 51 of FIG. 4, but further includes a low pass filtering block 81, one or more bandpass filters 83, and a high pass filter block 85. Each of the second audio signal mic2(t) 37 and the first audio signal mic1(t) 35 are passed through the filter blocks 81-85 to form a plurality of filtered first audio signals mic1_{f}(t) 87 and a plurality of filtered second audio signals mic2_{f}(t) 89. More specifically, each filter block 81-85 attenuates the portions of the first audio signal mic1(t) 35 and the second audio signal mic2(t) 37 that are not passed by the filter. As is commonly known in the art, a low pass filter employed by the low pass filtering block 81 will “pass” or allow signals below a cutoff frequency, and attenuate signals above the cutoff frequency. A bandpass filter as employed by the bandpass filter block 83 attenuates sounds below a first cutoff frequency and above a second cutoff frequency, and passes signals between the first and second cutoff frequencies. A high pass filter functions the opposite of the low pass filter, and passes signals above the cutoff frequency and attenuates signals below the cutoff frequency. Overall, the filter blocks 81-85 cause the first audio signal mic1(t) 35 and the second audio signal mic2(t) 37 to be split into frequency bands such that each of the plurality of filtered first audio signals mic1_{f}(t) 87 and the plurality of filtered second audio signals mic2_{f}(t) 89 contain a separate frequency domain portion, or bandwidth, of their respective input signal. This filtering may take place completely in the time domain, or by using masks and weights in the frequency domain. It is assumed throughout this text that all band processing is achieved in the time domain either through Infinite Impulse Response (IIR) or Finite Impulse Response (FIR) filtering blocks.

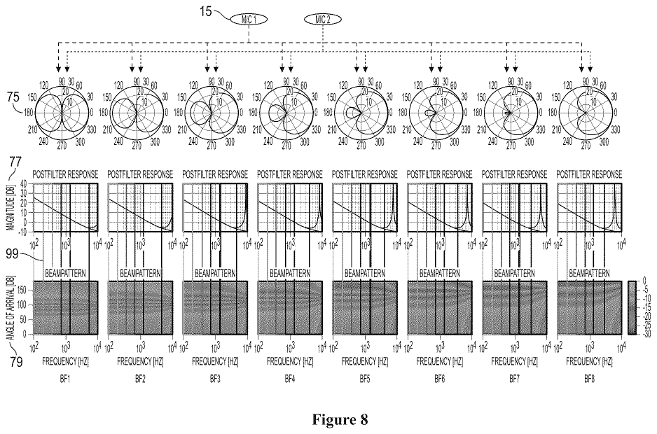

As a result of splitting the first audio signal mic1(t) 35 and the second audio signal mic2(t) 37 into frequency bands with the multi-bandpass filtering block 81, both the differential beamformer block 39 and the DAS beamformer block 63 receive a plurality of filtered first audio signals mic1_{f} (t) 87 and a plurality of filtered second audio signals mic2_{f}(t) 89. Differential beams (n,t) are formed in each frequency band, such that a plurality of differential beamformers created by the differential beamformer block 39 are applied to the plurality of filtered first audio signals mic1_{f} (t) 87 and the plurality of filtered second audio signals mic2_{f}(t) 89 for each frequency band. Similarly, the DAS beamformer block 63 forms a DAS beam (n,t) for each frequency band, such that the DAS beamformer block 63 outputs a plurality of DAS beams (n,t) with each DAS beam (n,t) being associated with a separate bandwidth. The plurality of filtered differential beams and the plurality of DAS beams formed by the differential beamformer block 39 and the DAS beamformer block 63, respectively, are denoted as beams (n,t) 91 in FIG. 8 for simplicity.

The beams (n,t) 91 are subsequently passed to a beam selection block 93. The beam selection block 93 is formed of multiple minimum energy detection block 43 and crossfade block 47 pairings. Each minimum energy detection block 43 and crossfade block 47 pairing receives beams (n,t) 91 that have passed through the same filter. For example, FIG. 7 depicts three pairs of a minimum energy detection block 43 and a crossfade block 47. A first pair of the minimum energy detection block 43 and the crossfade block 47 receives beams (n,t) 91 that were filtered by the low pass filtering block 81. Similarly, a second pair of the minimum energy detection block 43 and the crossfade block 47 receive beams (n,t) 91 that were filtered by a bandpass filter 83. The final pair of minimum energy detection block 43 and crossfade block 47 receives beams (n,t) 91 filtered by the high pass filter block 85. Thus, the number of pairs of minimum energy detection block 43 and crossfade block 47 forming the beam selection block 93 corresponds directly to the number of filters implemented prior to the beamformer blocks 39, 63.

Each minimum energy detection block 43 depicted in FIG. 7 determines an index (n) of the beam 91 having the lowest energy level in a particular bandwidth using process(es) discussed above. Each crossfade block 47 functions to crossfade between beams corresponding to the selected beam indices 45 output by the associated minimum energy detection block 43, and each crossfade block 47 outputs a partial output signal 95, where each partial output signal 95 is associated with a particular bandwidth. A sum block 97 is implemented after the beam selection block 93, and functions to add the audio samples forming the partial output signals 95 on a sample-by-sample basis to form a crossfaded output audio signal out_{x_fade} (t) 49 encompassing the entire bandwidth. The multi-band approach depicted in FIG. 7 advantageously allows a unique beam to be preferred in each frequency band, which increases system SNR. Since there may be multiple acoustic noise sources, each with a unique incident angle to the microphone array and unique power spectral density, it is expected that each band may have a unique balance between directivity enhancement, wind sensitivity, and electrical noise floor, giving opportunity for increased SNR when selecting the best beam in each band.

Turning to FIG. 8, FIG. 8 provides a visual depiction of the multi-band beamforming process, similar to FIG. 6. FIG. 8 is organized as a series of rows and columns. The top row of FIG. 8 depicts polar patterns 75, the middle row depicts postfilter shape 77, and the bottom row of FIG. 8 depicts beampatterns 79 of beams (n,t) 91 formed by a signal processing algorithm 51. The columns of FIG. 8 denote separate beamformers that are distinct by virtue of a unique delay and/or beamformer type being associated therewith. For example, the column denoted “BF1” in FIG. 8 may be associated with a differential beamformer, while the column denoted “BF8” in FIG. 1 may correspond to a DAS beamformer. A first microphone capsule 15 and a second microphone capsule 15 are depicted in FIG. 8 to represent that each resulting differential beam (n,t) 41 is formed using the first audio signal mic1(t) 35 and the second audio signal mic2(t) 37.

As shown in FIG. 8, the beamformers implemented by the signal processing algorithm 51 in a multi-band processing approach also form polar patterns 75 having sensitivities that vary as a function of sound incident angle. That is, the polar patterns 75 in a multi-band approach include “dipole”, “hyper-cardioid”, and “cardioid” shaped polar patterns 75, and other patterns with null angles placed between 90 degrees and 180 degrees and their reflection across the 0-180 axis. The postfilter shapes 77 and the beampatterns 79 are depicted with filters 99 band ranges overlaid thereon. Although only one filter 99 range is labeled for the sake of visual clarity, it will be appreciated to a person having ordinary skill in the art that multiple filter 99 band ranges are depicted in FIG. 8. Each filter 99 band range represents the range of frequencies over which one of the filter blocks 81-85 discussed in relation to FIG. 7 may exert on the signals mic1 and mic2. As discussed above, the filter blocks 81-85 include low-pass filters, bandpass filters, and high-pass filters. The leftmost filter 99 of each beamformer represents a low-pass filter, and attenuates sounds with frequencies higher than a cutoff frequency (i.e., 250 Hz in FIG. 8). This is the lowest frequency band range, and will experience the most significant wind turbulence activity over time. The rightmost filter 99 for each differential beamformer also represents a low-pass filter, and attenuates frequencies above another cutoff frequency (i.e., approximately 5 kHz, depending on array 13 structure and beamformer design). This right-most filter removes the aliasing region which will be filled in by a later stage DAS beamformer which doesn't suffer from aliasing on the design axis. The remaining four filters 99 form examples of bandpass filters that attenuate frequencies above and below associated cutoff frequencies.

From the beampatterns 79 it can be seen that the filters 99 serve to separate the audio signals 35, 37 into distinct bandwidths, which are then optimally processed within the bounds of each band in blocks 39, 63, 43, 47, and 97, and which are subsequently recombined such that the total crossfaded output audio signal out_{x_fade} (t) 49 represents the full original bandwidth (i.e., 50 Hz-20 kHz) As discussed above, the low-pass filter serves to attenuate sounds having a frequency above the spatial aliasing frequency limit, such that the low-pass filter is positioned immediately prior to the Dirac-shaped portion of each postfilter noise penalty visualizations 77. The spatial aliasing region is also crossed over in DAS beamforming, as DAS beams enhance a target signal without spatial distortion and do not experience spatial aliasing as a consequence thereof, on the design axis. Thus, as a result of the high pass filter and the use of a DAS beamformer, sounds occupying the spatial aliasing region do not appear in the resulting crossfaded output audio signal out_{x_fade} (t) 49. The number of bandpass filters 99 depicted in FIG. 8 is four filters as noted above. Increasing the number of bandpass filters increases the processing overhead incurred by the DSP 23, whereas decreasing the number of bandpass filters decreases SNR. Thus, the number of bandpass filters corresponds to the contemplated environment of the microphone array 13 and similar design considerations in order to avoid overloading the DSP 23 and provide sufficient filtering functionality to increase overall SNR. However, since there is overlap between the bands, caused by the finite slopes of the band edges, SNR improvement will approach a limit since overlapping band edges can result in the addition of two polar patterns (the left band might be a cardioid selection whereas the adjacent right band has selected a FIG. 8 pattern), and this addition is not guaranteed to be optimally beneficial. It is for this reason that band edge slopes need to increase correspond to the number of bands, to minimize out-of-band bleed and polar pattern “smearing” at each crossover region.

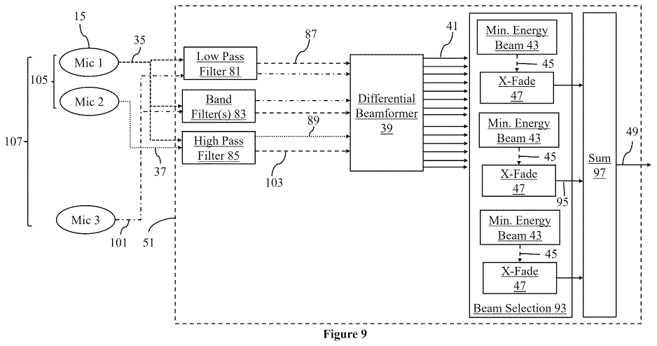

FIG. 9 depicts a signal processing algorithm 51 that receives signals from three microphone capsules 15. The three microphone capsules 15 are denoted as “Mic 1,” “Mic 2,” and “Mic 3” for the sake of simplicity. A first pair 105 of the microphone capsules 15 (i.e., Mic 1 and Mic 2) are separated by a first distance, and a second pair 107 of the microphone capsules 15 (i.e., Mic 1 and Mic 3) are separated by a second distance that is greater than the first distance. For example, Mic 1 and Mic 2 may be separated by a distance of 7 mm, whereas Mic 1 and Mic 3 may be separated by a distance of 28 mm. Microphone capsule 15 spacing and the null angle created by the beamformer design determine the postfilter gain, and therefore the shape and amplification of signals such as wind and electrical self-noise of the capsules. Capsule spacing and null angle placement also determine the spatial aliasing region. A multi-spacing approach as depicted in FIG. 9 results in improvements in SNR across the frequency spectrum, by helping to manage these tradeoffs as described further below.

The first microphone capsule 15 outputs a first audio signal mic1(t) 35, the second microphone capsule 15 outputs a second audio signal mic2(t) 37, and the third microphone capsule 15 outputs a third audio signal 101. The first audio signal mic1(t) 35 and the third audio signal 101 are passed to a low pass filtering block 81 and one or more bandpass filters 83. The high pass filter block 85 receives the first audio signal mic1(t) 35 and the second audio signal mic2(t) 37, similar to FIG. 7. The close spacing of the first pair 105 allows for the creation of optimum polar patterns at higher frequencies, with an aliasing region high in frequency, effectively extending the usable high frequency range covered by a differential beampattern. This, however, is a trade off since the penalty for a very small spacing between capsules is increased post filter gain, thus increasing sensitivity for lower frequency uncorrelated sources like wind and electrical self-noise. On the other hand, the wide spacing of the second pair 107 allows for reduced post filter gain, but at the cost of reduced bandwidth and a larger physical packaging space.

The filter blocks 81-85 transmit filtered first audio signals mic1_{f}(t) 87, filtered second audio signals mic2_{f}(t) 89, and filtered third audio signals mic3_{f}(t) 103 to a differential beamformer block 39. The differential beamformer block 39 proceeds to form differential beams (n,t) 41 from the plurality of filtered audio signals using delay functions, difference functions, and postfiltering functions as discussed in relation to FIG. 3. In this regard, differential beams (n,t) 41 formed by the differential beamformer block 39 correspond to either the first pair 105 or the second pair 107 of microphone capsules 15. Each differential beam (n,t) 41 is thus processed through one of the filter blocks 81-85 associated with the particular beamformer, and is formed on the basis of audio signals filtered to a particular frequency band. The differential beams (n,t) 41 are transmitted to a beam selection block 93 that includes multiple pairs of a minimum energy detection block 43 and a crossfade block 47, similar to FIG. 7.

Each minimum energy detection block 43 is associated with one of the filter blocks 81-85, and only receives audio signals filtered thereby. Thus, each minimum energy detection block 43 selects the audio signal having the lowest energy (or absolute magnitude) and generated by a beamformer associated with the same filter block on a sample by sample basis. The crossfade blocks 47 are each associated with a corresponding minimum energy detection block 43, and receives a selected beam index (n) 45 therefrom. Each crossfade block 47 thus outputs a partial output signal 95 that crossfades between a previously selected beam and a currently selected beam, where the partial output signal 95 is effectively filtered to a single frequency band defined by one of the filters 81-85. The partial output signals 95 are fed to a sum block 97, which sums each partial output signal 95 on a sample by sample basis to generate an output signal out (t) 49 that combines the audio signals occupying each frequency band into a single full bandwidth output signal. Furthermore, because microphone capsules 15 spacing and the beamformer null angle determine the spatial aliasing region and the resulting post filter gain applied by the differential beamformer block 39, a multi-band multi-spacing embodiment of the microphone array 13 as depicted in FIG. 9 results in further improvement in SNR across the frequency spectrum. The SNR enhancement offered by the system of FIG. 9 is achieved by actively managing the tradeoffs between usable bandwidth, self-noise, capsule sensitivity tolerance, processing complexity and physical array size.

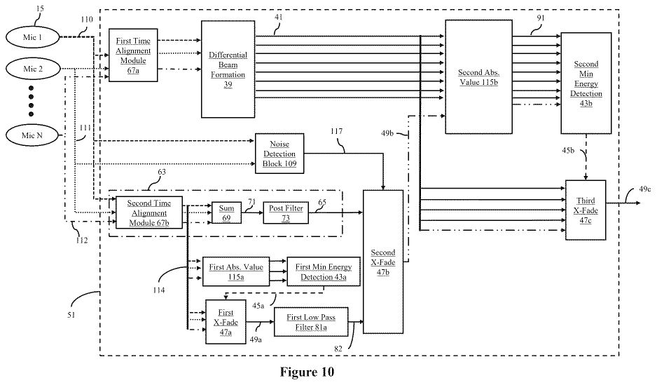

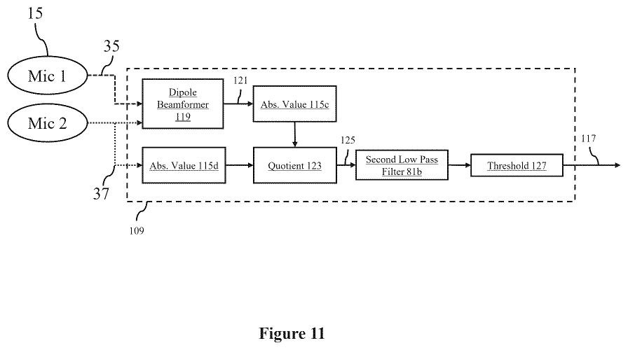

FIGS. 10 and 11 collectively depict a signal processing algorithm 51 that includes a wind detection block 109. The wind detection block 109 is depicted in the broader context of a signal processing algorithm 51 in FIG. 10, and a specific example of a wind detection block 109 is depicted in FIG. 11. The wind detection block 109 functions to determine if noise, particularly noise associated with wind, is present in audio signals captured by microphone capsules 15.

Specifically, FIG. 10 depicts a number “N” of microphone capsules 15, where each microphone capsule 15 outputs a separate audio signal. Specifically, the first microphone capsule 15 outputs a first series of audio signals mic1(t) 110, the second microphone capsule 15 outputs a second series of audio signals mic2(t) 111, and an N^{th} microphone outputs a third series of audio signals micN (t) 112. The audio signals mic(t) 110-112 are each transmitted to a first time alignment module 67a and a second time alignment module 67b. The first time alignment module 67a applies a delay (d_diff) to each received audio signal mic(t) that time and phase aligns the associated audio signal mic(t) with a common look axis. The common look axis ensures that each beam formed by the signal processing algorithm 51 responds identically to an acoustic source disposed on the look axis. In turn, for properly time aligned beams with a common look axis but unique null angles, the beam with the lowest instantaneous output magnitude or energy has the highest instantaneous signal-to-noise ratio (SNR), as the noise field will affect the beams differently.

It is noted that the first time alignment module 67a (i.e., associated with the differential beamformer block 39) also performs the functions of applying the maximum delay (d_c) applied by the second time alignment module 67b (i.e., associated with the DAS beamformer block 63) to all received audio signals mic(t) 110-112. On the other hand, the second time alignment module 67b associated with the DAS beamformer block 63 functions to apply a separate delay (d_DAS) to each audio signal mic(t) 110-112. The first time alignment module 67a thus allows for multiplexing between differential beams and DAS beams by compensating for the differences in beamforming techniques and ensuring a common look axis for each beam as discussed above, since the DAS block 63 has a time delayed output relative to a differential beam (n,t) output by the differential beamformer block 39. Audio signals mic(t) 110-112 that pass through the first time alignment module 67a are fed to the differential beamformer block 39, which generates a plurality of differential beams (n,t) 41 using a differential beamforming process as discussed above. Audio signals mic(t) 110-112 that pass through the second time alignment module 67b are denoted as delayed audio signals mic_{d_DAS} (t) 114. The delayed audio signals mic_{d_DAS} (t) 114 are formed into DAS beams (n,t) by the remainder of the DAS beamformer block 63, which includes a sum block 69 and a DAS postfilter block 73. The sum block 69 sums the delayed audio signals mic_{d_DAS} (t) 114 provided by the second time alignment module 67b to form a unfiltered DAS beam (n,t) 71, and the DAS postfilter block 73 applies at a minimum a “1/N” postfilter to the unfiltered DAS beam (n,t) 71 output by the sum block 69 to generate a DAS beam (n,t) 65. The sum block 69 and the post-filter block 73 may be replaced by other common methods such as filter-sum, MVDR, but the goal remains that the time aligned signals coming out of the second time alignment module 67b are to be combined in such a way to produce a beam which offers directivity without aliasing on the main lobe, even into the higher frequencies, and no increased sensitivity at any frequency to uncorrelated signal inputs. This is meant to complement the advantages and disadvantages known in the art for differential beamformers.

Below the DAS beamformer block 63 in FIG. 10, a first absolute value block 115a receives delayed audio signals mic_{d_DAS} (t) 114 from the second time alignment module 67b. The delayed audio signals mic_{d_DAS} (t) 114 include all audio signals generated by the plurality of microphone capsules 15. The first absolute value block 115a applies an absolute value function to each delayed delayed audio signals mic_{d_DAS} (t) 114 passing therethrough (i.e., abs (mic_{d_DAS} (t))), such that each audio signal output by the first absolute value block 115a only contains positive magnitudes. The first absolute value block 115a transmits the signals abs (mic_{d_DAS} (t)) to a first minimum energy detection block 43a, which functions to determine the signal abs (mic_{d_DAS} (t)) having the lowest instantaneous energy, or magnitude, on a sample by sample basis. The first minimum energy detection block 43a subsequently transmits a first selected beam index (n) 45a, indicating the delayed audio signal mic_{d_DAS} (t) 114 having the lowest energy to a first crossfade block 47a, and the first crossfade block 47a outputs a crossfaded delayed audio signal mic_{d_DAS_x_fade}(t) 49a that crossfades to the delayed audio signal mic_{d_DAS} (t) 114 corresponding to the first selected beam index (n) 45a. The crossfaded delayed audio signal mic_{d_DAS_x_fade}(t) 49a is output to a first low pass filtering block 81a. The first low pass filtering block 81a applies a lowpass filter to remove any crossfading artifacts from the crossfading operation, where a selected delayed audio signal mic_{d_DAS} (t) 114 has been faded in while the previously active delayed audio signal mic_{d_DAS} (t−1) 114 is simultaneously faded out. This filtered crossfaded signal is output to a second crossfade block 47b. The first absolute value block 115a, the first minimum energy detection block 43a, the first crossfade block 47a, and the first low pass filtering block 81a function to create a wind-desensitized signal wds(t) 82 which is minimally sensitive to uncorrelated signals such as signals generated by wind buffeting on the capsules 15. The first crossfade block 47 preceding the first low pass filtering block 81a is configured to quickly fade to the selected minimum energy time-aligned signal. Similar to the approach of crossfading between multiple beams, crossfading between multiple time aligned omnidirectional microphone capsules 15 ensures that the wind-desensitized signal wds(t) 82 output by the first low pass filtering block 81a will have lower wind related noise but the same signal of interest when comparing to the average of signals output by similarly low pass filtered omnidirectional capsules during the same time moment (i.e., the DAS beam (n,t) 65).

The second crossfade block 47b also receives the DAS beam (n,t) 65, and further receives a control signal 117 from the wind detection block 109. The generation of the control signal 117 is further discussed in relation to FIG. 11 below. The control signal 117 determines whether the second crossfade block 47b should output a beam (n,t) 65 or a wind-desensitized signal 82 output by the first low pass filtering block 81a to the remainder of the signal processing algorithm 51. In this regard and as discussed above, the postfilter 73 applied in the differential beamformer block 39 has a “1/f” shape that progressively adds gain at lower frequencies. Thus, low frequency noise, such as wind, is amplified by the differential beamformer postfilter block 73.

As a result of the above, it is desirable to react to the presence of wind with the use of a control signal 117, produced by a wind detection block 109, that is compared against a predetermined threshold. If wind or other non-acoustic stimuli is not detected, then the DAS signal 65 will be chosen in the second crossfade block 47b, to eventually be weighed against all the differential beams to produce a crossfaded output audio signal out_{x_fade}(t) 49c which is most advantageous given then current acoustic environment. On the other hand, if wind is detected, then the second crossfade block 47 fades in the output of the first low pass filtering block 81a, which is the wind-desensitized signal wds(t) 82. The wind-desensitized signal wds(t) 82 output by the first low pass filtering block 81a includes crossfading artifacts which are born from the occasional discontinuity of amplitudes when rapidly crossfading between all the time aligned signals mic(t) 110-112. During wind detected states, this wind desensitized signal is preferred even though it contains some degree of amplitude discontinuity distortions, which manifest as higher frequency harmonics thus making the use of the first low pass filtering block 81a desirable. The wind detector block 109 prevents these subtle distortions from appearing in the final crossfaded output audio signal out_{x_fade}(t) 49c (i.e., exiting the signal processing algorithm 51) in moments when wind is not present.

The second crossfade block 47b outputs a second crossfaded output audio signal out_{x_fade} (t) 49b to a second absolute value block 115b. The second absolute value block 115b receives both the second crossfaded output audio signal out_{x_fade} (t) 49b and the plurality of differential beams (n,t) 41 generated by the differential beamformer block 39. The second absolute value block 115b takes the absolute value of each sample passing therethrough, ensuring that signals output by the absolute value block 115b have a positive magnitude. A plurality of beams (n,t) 91 are output by the absolute value block 115b, including the second crossfaded output audio signal out_{x_fade}(t) 49b and the plurality of differential beams (n,t) 41, to a second minimum energy detection block 43b. The second minimum energy detection block 43b functions to determine which of the plurality of differential beams (n,t) 41 and the second crossfaded output audio signal out_{x_fade}(t) 49b has the lowest energy level, and outputs a second selected beam index (n) 45b corresponding to the beam 91 having the lowest energy level. A third crossfade block 47c crossfades between the beams (n,t) 91 and generates a third crossfaded output audio signal out_{x_fade}(t) 49c from samples of the beams (n,t) 91.

As a result of the inclusion of the wind detection block 109, the signal processing algorithm 51 depicted in FIG. 10 offers both high directivity and low sensitivity to uncorrelated noise sources, such as wind. In addition, the signal processing algorithm 51 of FIG. 10 allows for the possibility for delayed audio signals mic_{d_DAS} (t) 114 output by microphone capsules 15 and delayed by the time alignment module 67 to be included in the second crossfaded output audio signal out_{x_fade} (t) 49b, without going through a beamforming process. Such can be beneficial in quiet environments with low background noise, such that directional beamforming processes are not necessary to reduce the background noise below the acceptable threshold.

FIG. 11 depicts one embodiment of a wind detection block 109 in accordance with one or more embodiments of the invention. The wind detection block 109 functions as an instantaneous detection function for uncorrelated signals, and a control signal 117 output by the wind detection block 109 is utilized to steer which of the two signals (DAS beam (n,t) 65 or wind-desensitized signal wds(t) 82 output by the first low pass filtering block 81a) is transmitted to the second absolute value block 115b from the second crossfade block 47b. As depicted in FIG. 11, a dipole beamformer block 119 of the wind detection block 109 receives a first audio signal mic1(t) 35 directly from a first microphone capsule 15 and a second audio signal mic2(t) 37 directly from a second microphone capsule 15. The dipole beamformer block 119 functions to subtract the second audio signal mic2(t) 37 from the first audio signal mic1(t) 35, apply an appropriate post filter with gain and 1/f shape, thereby creating a dipole beam (n,t) 121 having a dipole beampattern. Such a dipole beampattern is depicted as the leftmost polar pattern 75 associated with BF1 in FIGS. 6 and 8.

The output of the dipole beamformer block 119 is a dipole beam (n,t) 121, which is subsequently passed through a third absolute value block 115c. The third absolute value block 115c converts negative signal components of the dipole beam (n,t) 121 to their positive counterparts such that the dipole beam (n,t) 121 has a positive amplitude. The third absolute value block 115c subsequently passes the dipole beam (n,t) 121 to a quotient block 123. In tandem, a fourth absolute value block 115d receives the second audio signal mic2(t) 37 and converts negative signal components thereof to their positive counterparts, and outputs the second audio signal mic2(t) 37 to the quotient block 123 as well. The quotient block 123 thus receives the dipole beam (n,t) 121 from the third absolute value block 115c and the second audio signal mic2(t) 37 from the fourth absolute value block 115d.

The quotient block 123 proceeds to determine the quotient of the received signals by dividing samples of the dipole beam (n,t) 121 by samples of the second audio signal mic2(t) 37 on a sample by sample basis. The determined quotients are output as a wind detection signal 125 to a second low pass filter block 81b, which removes frequency components less than 10 Hz. The inclusion of the second low pass filter block 81b is optional, and reduces the occurrence of false noise detection instances, trading off detection speed and detection confidence. After passing through the second low pass filter block 81b, the noise detection signal 125 is fed to a threshold block 127.

The threshold block 127 compares the samples of the low pass filtered noise detection signal 125 to a predetermined noise threshold selected by an operator or system manufacturer. If the current sample of the noise detection signal 125 has a magnitude less than the predetermined noise threshold (i.e., wind is not present) then the threshold block 127 outputs a control signal 117 indicating that the second crossfade block 47b of FIG. 10 should fade in the DAS signal 65 to be included in the output signal out(t) 49. On the other hand, if the current sample of the low pass filtered noise detection signal 125 has a magnitude greater than the predetermined wind noise threshold (i.e., wind is present) then the threshold block 127 outputs a control signal 117 indicating that the second crossfade block 47b of FIG. 10 should fade in the wind-desensitized signal wds(t) 82 to be included in the first output signal out (t) 49. Thus, the inclusion of the wind detection block 109 allows the signal processing algorithm 51 to instantaneously detect if wind is present in the composition of the audio signals mic(t) 110-112, captured from the surrounding environment of the microphone array 13, and adjust the output signal composition accordingly.

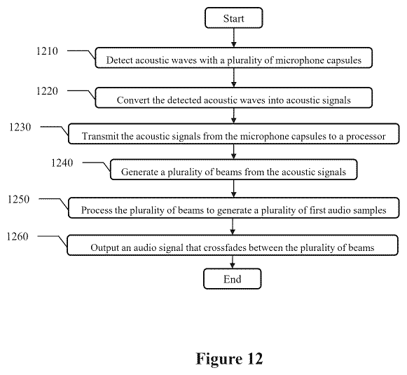

FIG. 12 presents a signal processing method consistent with one or more embodiments of the invention discussed above. Steps of the method presented in FIG. 12 may be performed, for example, using the microphone array 13 and signal processing algorithm 51 as discussed above, but are not limited thereto. The constituent steps of the method depicted in FIG. 12 may be performed in any logical order, and are not limited to the sequence presented. Furthermore, the steps of FIG. 12 may encompass multiple additional actions not depicted that are routine in the art. Moreover, multiple steps of FIG. 12 may be performed as part of a single action, or a single step may comprise multiple actions.

FIG. 12 initiates with step 1210, which includes detecting acoustic waves with a plurality of microphone capsules. The microphone capsules may be MEMS microphone capsules 15 as discussed above. In general, the method of FIG. 12 may be applicable to a microphone array 13 including a multitude of microphone capsules 15, and requires a minimum of two microphone capsules 15 to perform beamforming processes as discussed below. The acoustic waves are generated by one or more sound sources, including a source of interest and one or more sources of noise. Once the acoustic waves are captured by the microphone capsules 15, the method proceeds to step 1220.

In step 1220, the microphone capsules 15 convert the detected acoustic waves into acoustic signals. The acoustic waves received in step 1210 actuate flexible membranes of the microphone capsules 15, and the amount of actuation corresponds to the intensity of the captured acoustic wave. Step 1220 completes with each microphone capsule 15 outputting an acoustic signal that corresponds, in intensity, to the received acoustic waves.

Step 1230 includes transmitting the acoustic signals from the microphone capsules 15 to a Digital Signal Processor (DSP) 23. The acoustic signals are transferred from the microphone capsules 15 to the DSP 23 by way of one or more data connections 17. The data connection(s) 17 form electrically connective pathways between the microphone capsules 15 and the computing device 19. In embodiments where the microphone capsules 15 are separated by short distances, the data connection(s) 17 may be embodied as an electrically conductive layer of a printed circuit board (not shown). In embodiments of the audio processing system 11 where the microphone capsules 15 are separated by large distances, the data connection(s) 17 may be embodied as wiring harnesses (not shown). Once the acoustic signals are transmitted to the DSP 23, the method proceeds to step 1240.

In step 1240, a plurality of beams are generated from the acoustic signals received in step 1230. The beams may be formed by a differential beamformer block 39 and potentially a DAS beamformer block 63, depending on the particular embodiment of the microphone array 13 and signal processing algorithm 51. The resulting beams formed by the beamformer blocks include a plurality of differential beams (n,t) 41 and a DAS beam (n,t) 65. The differential beams (n,t) 41 are formed using a “delay and subtract” method that involves delaying signals of a far microphone capsule 15 relative to a near microphone capsule 15, and calculating the difference in magnitude. A DAS beamformer such as the DAS beamformer block 63 relies on the opposite principle of “delay and sum”, where the signals generated by a near microphone capsule 15 are delayed relative to the signals generated by a far microphone capsule 15. The terms “near” and “far” describe the relative position of microphone capsules 15 in relation to a sound source of interest. The beams are formed, by virtue of the delay function and the time and phase alignment process, such that each beam comprises an ideal on-axis response and a unique off-axis null angle. Once the plurality of beams (n,t) 41 are output by their associated beamformer blocks, the method proceeds to step 1250.

Step 1250 includes processing the beams (n,t) 41 to generate a plurality of audio samples. The beams 41 are received as intensity, or magnitude, values associated with a particular frequency on a time-series basis. Thus, the process of generating audio samples involves detecting intensity values of the associated signal that are subsequently mathematically processed. As noted above, the DSP 23 may have a processing rate of approximately 48 Kilohertz (kHz), and each sample is associated with a duration of a fraction of a second (on the order of milliseconds or hundredths of a second).

Step 1260 includes outputting an audio signal that crossfades between beams generated in step 1250. The output audio signal is discussed above as the crossfaded output audio signal out_{x_fade}(t) 49, and is formed of a plurality of audio samples. The audio samples for each beam (n,t) 41, are compared, on a moment by moment basis, to determine which audio sample has the lowest magnitude or energy level for the associated time period. Thus, the crossfaded output audio signal out_{x_fade}(t) 49 crossfades from a first beam associated with a first audio sample having a lowest energy level for a first sampling period (t−1) to a second beam associated with a second audio sample having the lowest energy level for a second sampling period (t). This process is repeated for any number of cycles, the same beam may be selected for multiple sampling periods such that a crossfade function is temporarily unnecessary. Overall, step 1260 concludes with generating the crossfaded output audio signal out_{x_fade} (t) 49, which has a greater SNR than the acoustic signals produced by the microphone capsules 15. In a real world application, a user listening to the crossfaded output audio signal out_{x_fade}(t) 49 will be able to clearly hear sounds originating from a source of interest without hearing an undue amount of background noise (or competing source) that detracts from the user's ability to hear and comprehend said sounds.

Although only a few example embodiments have been described in detail above, those skilled in the art will readily appreciate that many modifications are possible in the example embodiments without materially departing from this invention. For example, a multi-spacing multi-band embodiment with a wind detection block may be created by substantially combining the signal processing algorithms of FIGS. 9 and 10, or FIGS. 7 and 10. Furthermore, although the microphone capsules have been described as MEMS capsules above, the microphone capsules may be embodied as electret condenser microphones, dynamic microphones, ribbon microphone, piezo sensors, accelerometers, V2S sensors, etc. Additionally, a microphone array described herein is not limited to a particular environment, and may be used in an enclosed space (such as a room or vehicle), or an open space (such as a field) while still performing processes described herein. Similarly, the sources of noise and sources of interest are not limited to the examples presented herein, and it will be appreciated that sound may be generated by any number of sources without departing from the nature of this disclosure. Accordingly, all such modifications are intended to be included within the scope of this disclosure as defined in the following claims.

Furthermore, the compositions described herein may be free of any component or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. A method comprising:
detecting acoustic waves with a plurality of microphone capsules;
converting the detected acoustic waves into acoustic signals;
transmitting the acoustic signals from the plurality of microphone capsules to a processor with a data connection;
generating a plurality of beams from the acoustic signals with the processor using a plurality of beamformers, where each beam of the plurality of beams comprises an ideal on-axis response and a unique off-axis null angle;
processing the plurality of beams to generate a plurality of first audio samples, where each first audio sample of the plurality of first audio samples comprises a portion of a beam of the plurality of beams occupying one first sampling period of a plurality of first sampling periods, and each first audio sample is associated with a corresponding energy level, and
outputting an audio signal that crossfades, using a first crossfading function, between the plurality of beams by selecting, for each first sampling period, the beam corresponding to a first audio sample having a lowest energy level.

2. The method of claim 1, further comprising: phase aligning and time aligning the plurality of beams with a look angle directed to an acoustic source of interest that generates at least some of the acoustic waves, based upon one or more of: a distance between a pair of microphone capsules of the plurality of microphone capsules and a type of the plurality of beamformers.

3. The method of claim 1, further comprising: detecting disturbances caused by wind buffeting with the microphone capsules.

4. The method of claim 1, further comprising: applying a plurality of bandpass filters to the acoustic signals prior to generating the plurality of beams.

5. The method of claim 1, wherein the plurality of beamformers comprise a plurality of differential beamformers.

6. The method of claim 5, wherein the plurality of beamformers comprise at least one delay and sum beamformer.

7. The method of claim 1, further comprising: applying a first order postfilter to the plurality of beams prior to generating the first audio samples.

8. The method of claim 1, further comprising: forming a dipole beam signal using a dipole beamformer, and dividing the dipole beam signal by an acoustic signal of the plurality of acoustic signals to generate a control signal associated with non-acoustic stimuli detected by the plurality of microphone capsules.

9. The method of claim 8, further comprising: applying a second crossfade function to the control signal and a summed beam formed using a delay and sum beamformer, where the second crossfade function is configured to output a crossfaded signal that comprises a plurality of second audio samples, where each second audio sample of the plurality of second audio samples comprises a portion of either the control signal or the summed beam occupying one second sampling period of a plurality of second sampling periods, and the crossfaded signal comprises the second audio sample of each second sampling period that has the lowest energy level.

10. A system comprising:
a plurality of microphone capsules configured to detect acoustic waves and convert the detected acoustic waves into acoustic signals;
a signal processor configured to execute computer readable code, the computer readable code causing the signal processor to:
generate a plurality of beams from the acoustic signals with the signal processor using a plurality of beamformers, where each beam of the plurality of beams comprises an ideal on-axis response and a unique off-axis null angle;
process the plurality of beams to generate a plurality of first audio samples, where each first audio sample of the plurality of first audio samples comprises a portion of a beam of the plurality of beams occupying one first sampling period of a plurality of first sampling periods, and each first audio sample is associated with a corresponding energy level, and
output an audio signal that crossfades, using a first crossfading function, between the plurality of first audio samples by selecting, for each first sampling period, a first audio sample having a lowest energy level, and
a data connection configured to transmit the acoustic signals from the plurality of microphone capsules to the signal processor.

11. The system of claim 10, wherein the computer readable code further causes the signal processor to phase align and time align the plurality of beams with a look angle directed to an acoustic source of interest that generates at least some of the acoustic waves, based upon one or more of: a distance between a pair of microphone capsules of the plurality of microphone capsules and a type of the plurality of beamformers.

12. The system of claim 10, wherein the computer readable code further causes the signal processor to apply a plurality of bandpass filters to the acoustic signals prior to generating the plurality of beams.

13. The system of claim 10, wherein the computer readable code further causes the signal processor to phase align and time align the plurality of beams with a look angle directed to an acoustic source of interest that generates at least some of the acoustic waves, where the signal processor phase aligns and the time aligns the plurality of beams based upon a distance between a pair of microphone capsules of the plurality of microphone capsules.

14. The system of claim 10, wherein the plurality of microphone capsules are configured to detect disturbances caused by wind buffeting.

15. The system of claim 10, wherein the plurality of beamformers comprise a plurality of differential beamformers.

16. The system of claim 15, wherein the plurality of beamformers comprise at least one delay and sum beamformer.

17. The system of claim 10, wherein the computer readable code further causes the signal processor to apply a first order postfilter to the plurality of beams prior to generating the plurality of first audio samples.

18. The system of claim 10, wherein the computer readable code further causes the signal processor to form a dipole beam signal using a dipole beamformer, and divide the dipole beam signal by an acoustic signal of the acoustic signals to generate a control signal associated with non-acoustic stimuli detected by the plurality of microphone capsules.

19. The system of claim 18, wherein the computer readable code further causes the signal processor to apply a second crossfade function to the control signal and a summed beam formed using a delay and sum beamformer, where the second crossfade function is configured to output a crossfaded signal that comprises a plurality of second audio samples, where each second audio sample of the plurality of second audio samples comprises a portion of either the control signal or the summed beam occupying one second sampling period of a plurality of second sampling periods, and the crossfaded signal comprises the second audio sample of each second sampling period that has the lowest energy level.

20. A non-transitory Computer Readable Medium (CRM) storing instructions for performing operations, the operations comprising:
detecting acoustic waves with a plurality of microphone capsules;
converting the detected acoustic waves into acoustic signals;
transmitting the acoustic signals from the plurality of microphone capsules to a processor with a data connection;
generating a plurality of beams from the acoustic signals with the processor using a plurality of beamformers, where each beam of the plurality of beams comprises an ideal on-axis response and a unique off-axis null angle;
processing the plurality of beams to generate a plurality of first audio samples, where each first audio sample of the plurality of first audio samples comprises a portion of a beam of the plurality of beams occupying one first sampling period of a plurality of first sampling periods, and each first audio sample is associated with a corresponding energy level, and
outputting an audio signal that crossfades, using a first crossfading function, between the plurality of beams by selecting, for each first sampling period, the beam corresponding to a first audio sample having a lowest energy level.
